(19) United States
(12) Patent Application Publication
(10) Pub. No.: US 2016/0104179 A1
(43) Pub. Date: Apr. 14, 2016

(54) METHOD, SERVER, AND APPARATUS FOR LECTURE FEEDBACK

(71) Applicant: National Tsing Hua University, Hsinchu City (TW)

(72) Inventors: Shan-Hung Wu, Hsinchu (TW); Meng-Ren Chen, Taichung City (TW)

(21) Appl. No.: 14/583,202

(22) Filed: Dec. 26, 2014

(30) Foreign Application Priority Data
Oct. 14, 2014 (TW) 103135519

(51) Int. Cl. G06Q 30/02

(52) U.S. Cl. CPC G06Q 30/0203

(57) ABSTRACT

A method, a server and an apparatus for lecture feedback are provided. In the method, an adding request is received to establish a lecture. A login for the lecture from each of at least one audience apparatus is received to provide a presentation data to each of the at least one audience apparatus. The presentation data includes several pages. A usage behavior of each audience apparatus executing on each of the pages of the presentation data is monitored, and the usage behaviors of all of the at least one audience apparatus are analyzed to provide a feedback of the lecture.

### CROSS-REFERENCE TO RELATED APPLICATION

This application claims the priority benefit of Taiwan application serial no. 103135519, filed on Oct. 14, 2014. The entirety of the above-mentioned patent application is hereby incorporated by reference herein and made a part of this specification.

### BACKGROUND

1. Field of the Invention

The invention is directed to a method, a server and an apparatus for lecture feedback and more particularly, to a method, a server and an apparatus capable of analyzing usage behaviors of audience executing on presentation data so as to provide lecture feedback.

2. Description of Related Art

In various types of conferences, speakers can share knowledge, experiences or job contents through lectures. In most occasions, the speakers provide the audience with time to ask questions after the lecture for answering the questions of the audience on presentation contents. However, perhaps due to lengthy lecture processes, some audience may forget what they doubt about the presentation. Or, perhaps because the audience hesitate to raise hands, cannot bear or feel inconvenient to interrupt the proceeding of the lecture, or because the speakers are unable to collect and category the questions raised by the audience, the speakers turn out to be unable to obtain feedback from the audience.

Current applications for assisting lecture can only allow the audience to raise questions during the lectures and collect question contents of the audience to assist the speakers in acquiring the questions of the audience on the lectures. However, the applications only function in collecting the questions, but cannot facilitate to acquire the questions or interests arisen by the audience in each part of the lectures.

### SUMMARY

The invention provides a method, a sever and an apparatus for lecture feedback capable of analyzing usage behaviors of audience apparatuses executing on presentation data during a lecture, so as to provide effective feedback of the lecture.

The invention is directed to a method for lecture feedback adapted to provide a feedback of a lecture. The method includes the following steps. First, an adding request is received to establish the lecture. Next, a login for the lecture is received from at least one audience apparatus to provide presentation data used in the lecture for each of the at least one audience apparatus. The presentation data comprises a plurality of pages. Then, a usage behavior of each of the at least one audience apparatus executing on each of the pages of the presentation data is monitored. Finally, the usage behaviors of all of the at least one audience apparatus are analyzed to provide the feedback of the lecture.

In an embodiment of the invention, the step of receiving the adding request to establish the lecture includes broadcasting an identification (ID) of the lecture and receiving the presentation data uploaded by using the ID.

In an embodiment of the invention, the step of receiving the login for the lecture from each of the at least one audience apparatus includes receiving login information uploaded by each of the at least one audience apparatus and determining whether to accept the login for the lecture of each of the at least one audience apparatus according to the login information. The login information includes the ID of the lecture or location information of each of the at least one audience apparatus.

In an embodiment of the invention, the step of monitoring the usage behavior of each of the at least one audience apparatus executing on each of the pages of the presentation data includes monitoring one or a combination of a duration of each of the at least one audience apparatus staying on each of the pages, contents marked on each of the pages, questions raised during a display of each of the pages, a reply to each of the questions, a sequence of reading each of the pages and a frequency of switching each of the pages.

In an embodiment of the invention, the step of analyzing the usage behaviors of all of the at least one audience apparatus to provide the feedback of the lecture includes accumulating the durations of all of the at least one audience apparatus staying on each of the pages to serve the accumulated result as the feedback of the lecture.

In an embodiment of the invention, the step of analyzing the usage behaviors of all of the at least one audience apparatus to provide the feedback of the lecture includes accumulating the number of the contents marked by all of the at least one audience apparatus on each of the pages to serve the accumulated number as the feedback of the lecture.

In an embodiment of the invention, the step of analyzing the usage behaviors of all of the at least one audience apparatus to provide the feedback of the lecture includes accumulating the number of the questions raised by all of the at least one audience apparatus during the display of each of the pages to serve the accumulated number as the feedback of the lecture.

In an embodiment of the invention, the step of analyzing the usage behaviors of all of the at least one audience apparatus to provide the feedback of the lecture includes accumulating the number of the questions raised by all the at least one audience apparatus during the display of each of the pages, the number of the replies to the questions and the number of assessments of the questions to serve the accumulated numbers as the feedback of the lecture.

In an embodiment of the invention, after the step of analyzing the usage behaviors of all of the at least one audience apparatus to provide the feedback of the lecture, the method further includes receiving an inquiry request sent by the at least one audience apparatus to provide the presentation data with the marks adding to each of the pages or a list of the questions collected for each of the pages.

The invention is directed to a server for lecture feedback. The server includes a communication unit, a storage unit and a processing unit. The processing unit is coupled to the communication unit and the storage unit and configured to access and execute a plurality of modules recorded in the storage unit. The modules include a lecture establishing module, a login management module and a behavior analysis module. The lecture establishing module receives an adding request sent by a speaker apparatus through the communication unit to establish a lecture. The login management module receives a login for the lecture from at least one audience apparatus through the communication unit to provide a presentation data used in the lecture for each of the at least one audience apparatus. The presentation data comprises a plurality of page. The presentation data includes a plurality of pages. The behavior analysis module monitors a usage behavior of each of the at least one audience apparatus executing on each of the pages of the presentation data and analyzes the usage behaviors of all of the at least one audience apparatus to provide a feedback of the lecture through the communication unit.

In an embodiment of the invention, the lecture establishing module broadcasts an ID of the lecture through the communication unit, and receives the presentation data uploaded by the speaker apparatus using the ID through the communication unit.

In an embodiment of the invention, the login management module receives login information uploaded by each of the at least one audience apparatus through the communication unit, and determines whether to accept the login for the lecture of each of the at least one audience apparatus according to the login information. The login information includes the ID of the lecture or location information of each of the at least one audience apparatus.

In an embodiment of the invention, the behavior analysis module monitors one or a combination of a duration of each of the at least one audience apparatus staying on each of the pages, contents marked on each of the pages, questions raised during a display of each of the pages, a reply to each of the questions, a sequence of reading each of the pages and a frequency of switching each of the pages.

In an embodiment of the invention, the behavior analysis module accumulates the durations of all of the at least one audience apparatus staying on each of the pages to serve the accumulated result as the feedback of the lecture.

In an embodiment of the invention, the behavior analysis module accumulates the number of the contents marked by all of the at least one audience apparatus on each of the pages to serve the accumulated number as the feedback of the lecture.

In an embodiment of the invention, the behavior analysis module accumulates the number of the questions raised by all of the at least one audience apparatus during the display of each of the pages to serve the accumulated number as the feedback of the lecture.

In an embodiment of the invention, the behavior analysis module accumulates the number of the questions raised by all of the at least one audience apparatus during the display of each of the pages, the number of the replies to the questions and the number of assessments of the questions to serve the accumulated numbers as the feedback of the lecture.

In an embodiment of the invention, the modules further include a presentation data updating module receiving an inquiry request sent by the speaker apparatus or the at least one audience apparatus through the communication unit to provide the presentation data with the marks adding to each of the pages or a list of the questions collected for each of the pages through the communication unit.

The invention is directed to an apparatus for lecture feedback. The apparatus includes a communication unit, storage unit and a processing unit. The processing unit is coupled to the communication unit and the storage unit and configured to access and execute a plurality of modules recorded in the storage unit. The modules include a lecture establishing module, a login management module and a behavior analysis module. The lecture establishing module receives an adding request sent by a speaker apparatus through the communication unit to establish a lecture. The login management module receives a login for the lecture from at least one audience apparatus through the communication unit to provide a presentation data used in the lecture for each of the at least one audience apparatus. The presentation data comprises a plurality of page. The behavior analysis module monitors a usage behavior of each of the at least one audience apparatus executing on each of the pages of the presentation data and analyzes the usage behaviors of all of the at least one audience apparatus to provide a feedback of the lecture through the communication unit.

In an embodiment of the invention, the behavior analysis module monitors one or a combination of a duration of each of the at least one audience apparatus staying on each of the pages, contents marked on each of the pages, questions raised during a display of each of the pages, a reply to each of the questions, a sequence of reading each of the pages and a frequency of switching each of the pages, so as to generate a feedback of the lecture.

To sum up, in the method, the server and the apparatus for lecture feedback of the invention, the usage behaviors of the audience apparatuses executing on each of the pages of the presentation data are monitored by the server or the lecture feedback apparatus and analyzed to provide the feedback of the lecture, which can facilitate the speaker obtaining effective feedback of the lecture from the audience during or after the lecture.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a lecture feedback system according to an embodiment of the invention.

FIG. 2 is a block diagram illustrating the server of the lecture feedback system depicted in FIG. 1 according to an embodiment of the invention.

FIG. 3 is a flowchart of a method for lecture feedback according to an embodiment of the invention.

FIG. 4 illustrates an example of the lecture feedback according to an embodiment of the invention.

FIG. 5 is a schematic diagram illustrating a lecture feedback system according to another embodiment of the invention.

FIG. 6 is a block diagram illustrating a lecture feedback apparatus of the lecture feedback system depicted in FIG. 5 according to an embodiment of the invention.

FIG. 7 is a flowchart of a method for lecture feedback according to an embodiment of the invention.

### DESCRIPTION OF EMBODIMENTS

During the process of lecture, audience commonly highlight or add notes on presentation data provided by a speaker, while the highlights or notes may reveal the audience questions or interests on the lecture contents. Accordingly, in the invention, which parts of the lecture that the audience having questions or interests on may be analyzed by monitoring, during the lecture, usage behaviors such as a duration of the audience staying on the highlights or the notes made on each page of the presentation data, such that effective feedback information may be provided to the speaker or the audience for reference. Thereby, not only the speaker can understand thoughts or questions of the audience, but also the audience can share experiences of the lecture with each other.

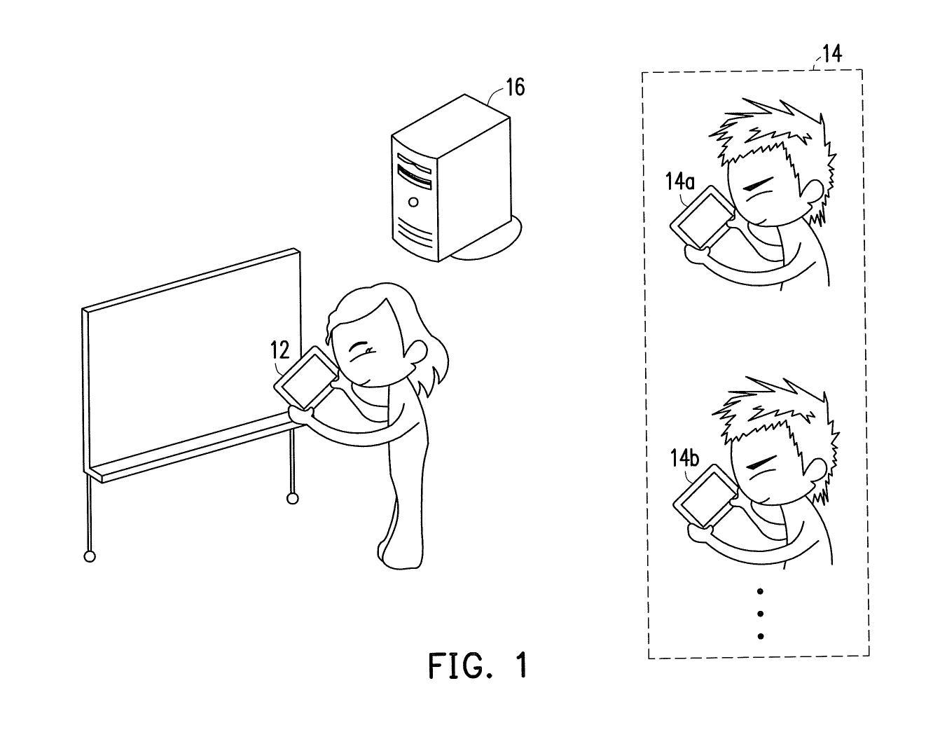

FIG. 1 is a schematic diagram illustrating a lecture feedback system according to an embodiment of the invention. Referring to FIG. 1, a lecture feedback system 10 of the present embodiment includes a speaker apparatus 12, at least one audience apparatus 14 (e.g., audience apparatuses 14a and 14b) and a server 16. The speaker apparatus 12 and the audience apparatuses 14 are electronic apparatuses, such as smart phones, personal digital assistants (PDAs), tablet computers, notebook computers or multi-media players. The server 16 is a computing apparatus, such as a file server with computing capability, a database server, an application server, a work station or a personal computer, whose type is not limited in the invention.

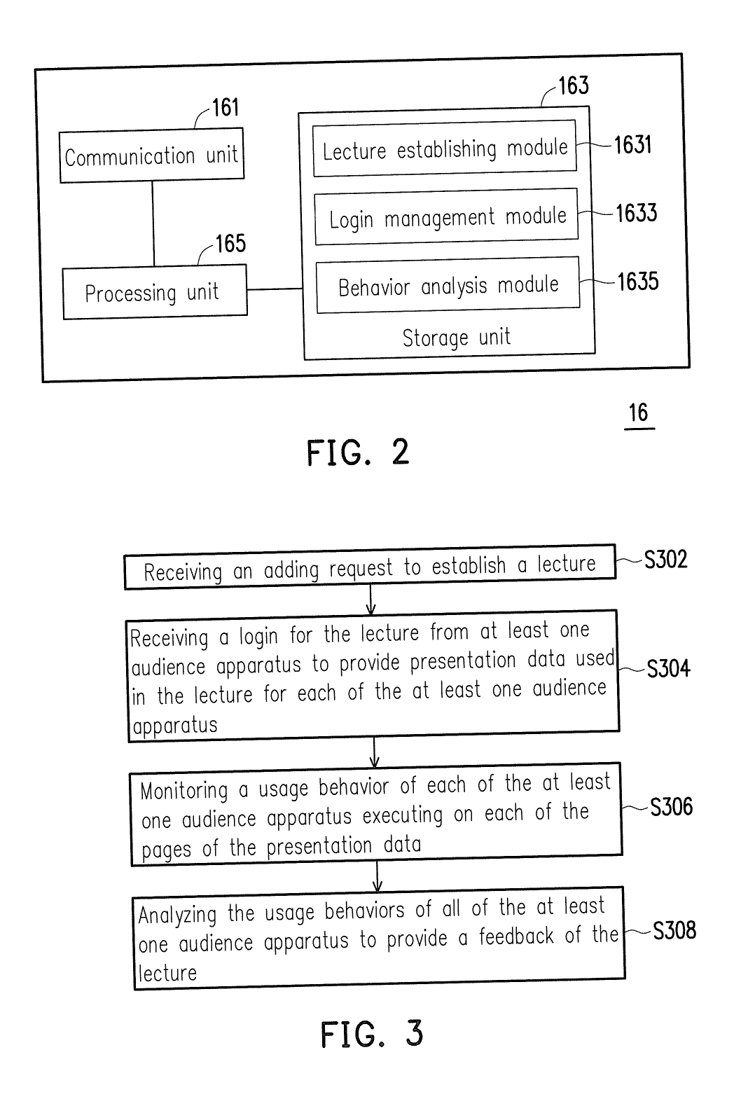

FIG. 2 is a block diagram illustrating the server 16 of the lecture feedback system 10 depicted in FIG. 1 according to an embodiment of the invention. Referring to FIG. 2, the server 16 includes a communication unit 161, a storage unit 163 and a processing unit 165 and functions thereof will be described below.

The communication unit 161 is, for example, a wireless communication module supporting wireless protocols, such as wireless fidelity (Wi-Fi), worldwide interoperability for microwave access (WiMAX), a 3rd generation partnership project (3GPP) standard and Bluetooth, or a wired communication module supporting Ethernet, optical fiber or any other wired transmission function. In the present embodiment, the server 16 may establish connection for data transmission with the speaker apparatus 12 or the audience apparatuses 14a and 14b through the communication unit 161 by using a peer-to-peer technique (e.g., device-to-device (D2D) or WiFi Direct) or by connecting the Internet.

The storage unit 163 is, for example, a hard disk, a fixed or a movable random access memory (RAM), read-only memory (ROM), flash memory or a similar component or a combination of those components. In the present embodiment, the storage unit 163 is configured to store software programs, such as a lecture establishing module 1631, a login management module 1633 and a behavior analysis module 1635. The storage unit 163 of the present embodiment is not limited to be a single memory component, and each of the software modules may be separately stored in two or more memory components of the same type or different types.

The processing unit 165 is, for example, a central processing unit (CPU) with single core or multiple cores, a microprocessor, a digital signal processor (DSP), a programmable controller, application specific integrated circuits (ASIC), a programmable logic device (PLD) or a similar device or a combination of those devices, which may load the aforementioned modules from the storage unit 163 and execute the modules to provide the lecture feedback function of the invention.

In detail, FIG. 3 is a flowchart of a method for lecture feedback according to an embodiment of the invention. Referring to FIG. 3, the method of the present embodiment is applicable to the server 16 of FIG. 2, and detailed steps of the method for lecture feedback of the present embodiment will be described with reference to the operation of each component of the server 16, the speaker apparatus 12 and the audience apparatuses 14 depicted in FIG. 1.

First, a lecture establishing module 1631 of the server 16 receives an adding request sent by the speaker apparatus 12 through the communication unit 161 so as to establish a lecture (step S302). In an embodiment, after the adding request sent by the speaker apparatus 12 is received by the server 16, the lecture establishing module 1631 of the server 16 generates an identification (ID) exclusively pertaining to the lecture and broadcasts the ID through the communication unit 161. Then, the lecture establishing module 1631 also receives presentation data uploaded by the speaker apparatus 12 by using the ID through the communication unit 161.

Specifically, the speaker apparatus 12 may transmit the adding request generated by the newly added lecture of the speaker to the server 16 directly through the connection between the speaker apparatus 12 and the server 16 or through the Internet. The lecture establishing module 1631 of the server 16 may generate and broadcast the ID corresponding to the newly added lecture according to the adding request received from the speaker apparatus 12. An application installed in the speaker apparatus 12 or a web page provided by the server 16 may allow the speaker to add the lecture to send the adding request, such that the lecture establishing module 1631 may provide the ID according to the adding request through the web page, or transmit the ID to the speaker apparatus 12 through the communication unit 161. In this way, the speaker apparatus 12 may obtain the ID through the web page or on the application.

When receiving the presentation data transmitted by the speaker apparatus 12 using the ID through the communication unit 161, the lecture establishing module 1631 may add presentation data to the lecture corresponding to the ID. For example, the application installed in the speaker apparatus 12 or the web page provided by the server 16 may allow the speaker to input the ID and select the presentation data to be uploaded and then, upload the ID input and the presentation data selected by the speaker to the server 16. After receiving the presentation data, the lecture establishing module 1631 adds the presentation data to the corresponding lecture according to the ID and stores the presentation data in the storage unit 161.

After the lecture is established and the presentation data is added by the lecture establishing module 1631, the login management module 1633 receives a login for the lecture from each audience apparatus 14 to provide the presentation data used in the lecture for each audience apparatus 14, where the presentation data includes a plurality of pages (step S304). Information for the login includes the ID of the lecture or location information of each audience apparatus 14.

To be detailed, in an embodiment, after receiving the ID sent by the server 16, each audience apparatus 14 returns the login information including the ID back to the server 16. When receiving the login information, the login management module 1633 compares the ID included in the login information with the ID of each lecture recorded in the storage unit 163 to determine the lecture that the speaker intends to participate in. When determining that the ID included in the login information matches a specific lecture ID, the login management module 1633 accepts each audience apparatus 14 to log in the lecture corresponding to the ID.

In another embodiment, each audience apparatus 14 may perform positioning to obtain location information with respect to where it is located by utilizing the global positioning system (GPS), surrounding base stations or hotspots and transmit the login information including the location information to the server 16. When receiving the login information through the communication unit 161, the login management module 1633 compares the location information of each audience apparatus 14 included in the login information with the location information of the speaker apparatus 12 or the location information of the server 16 to determine whether each audience apparatus 14 and the speaker apparatus 12 or the server 16 are located in the same place (e.g., located within a distance of 10 or 20 meters from each other), so as to determine whether to accept the login for the lecture of each audience apparatus 14. In brief, as if each audience apparatus 14 and the speaker apparatus 12 or the server 16 are located in the same place, the login management module 1633 may therefore determine that they will participate in the same lecture and accept the login of each audience apparatus 14.

Returning to the process illustrated in FIG. 3, in step S306, the behavior analysis module 1635 of the server 16 monitors a usage behavior of each audience apparatus 14 executing on each of the pages of the presentation data. For example, the behavior analysis module 1635 may monitor one or a combination of a duration of each audience apparatus staying on each page, contents marked on each page, questions raised during a display of each page, a reply to each question, a sequence of reading each page and a frequency of switching each page.

Specifically, each audience apparatus 14 may record the duration of displaying each page during the lecture. Each audience apparatus 14 may also retrieve the contents (e.g., highlights or notes) marked on each page by the audience. Additionally, each audience apparatus 14 may obtain a question raised by the audience during the display of each page or obtain a reply of the audience to the question raised by another audience apparatus 14, such as a replay showing support or nonsupport to the question or supplemental data to the question. Alternatively, the audience apparatus 14 may also obtain the sequence of the audience reading each page, for example, by recording a page number of a currently displayed page in a log list when a duration of displaying the page is over a predetermined value (e.g., 3 or 5 seconds), so as to obtain the sequence of the audience reading each page. Further, the audience apparatus 14 may further obtain a frequency of the audience switching each page, for example, by accumulating a number of the audience switching the pages using a page-switching counter and calculating the frequency of switching each page according the duration of displaying all the switched pages.

Data with respect to the usage behaviors collected by each audience apparatus 14 may be transmitted to the server 16 instantly or periodically, such that the server 16 may perform subsequent analysis. In detail, the server 16 may send a monitoring request to each audience apparatus 14 per a period (e.g., 30 seconds or 1 minute) to obtain a usage behavior of each audience apparatus 14, or alternatively, the audience apparatus 14 may directly transmit a usage behavior of each audience using the presentation data which is collected thereby to the server 16 per a period (e.g., 10 seconds or 15 seconds), which is not limited in the invention.

After receiving the usage behavior data transmitted by the audience apparatus 14, the behavior analysis module 1635 of the server 16 analyzes the usage behaviors of all of the audience apparatuses 14 to provide a feedback of the lecture through the communication unit 161 (step S308). The behavior analysis module 1635 analyze the usage behaviors, such as the durations of the audience apparatuses 14 staying on each page, the contents marked on each page, the questions raised during the display of each page and the replies to each question raised, to obtain the feedback of the lecture.

To be detailed, in an embodiment, the behavior analysis module 1635 accumulates the durations of all of the audience apparatuses 14 staying on each page to serve the accumulated result as the feedback of the lecture. The accumulated staying durations represent the duration of the audience paying attentions to each page, which may reflect degrees of the audience having questions or interests in each page.

In another embodiment, the behavior analysis module 1635 may accumulate the number of marks on each page made by all of the audience apparatuses 14 and serve the accumulated marking number as the feedback of the lecture. The marks include highlights and notes. The behavior analysis module 1635 may retrieve information with respect to the content marks, highlights or notes made on each page by all of the audience apparatuses 14 to accumulate the making number. The accumulated number may reflect how much attention that the audience pay to each page.

In yet another embodiment, the behavior analysis module 1635 accumulates the number of the questions raised by all of the audience apparatuses 14 during the display of each page to serve the accumulated number as the feedback of the lecture. For example, the audience apparatuses 14 may receive the questions raised by the audience during the lecture, and transmit the questions accompanying with information with respect to the pages displayed while the audience raise the questions to the server 16. The behavior analysis module 1635 of the server 16 then may calculate the number of the questions raised by the audience apparatuses 14 during the display of each page. The accumulated number may reflect degrees of the audience doubt about each page.

In still another embodiment, the behavior analysis module 1635 accumulates the number of the questions raised by all of the audience apparatuses 14 during the display of each page, the number of replies to the questions and the number of assessments of the questions to serve the accumulated numbers as the feedback of the lecture. Therein, the questions received by each of the audience apparatuses 14 during the display of each page are not only transmitted to the server 16, but also shared with the other audience apparatuses 14 participating in the lecture, such that the audience using the audience apparatuses 14 may reply to the questions. The behavior analysis module 1635 may calculate not only the number of the questions raised by each audience apparatus 14 during the display of each page, but also calculate the replies to the questions from the audience apparatuses 14. The accumulated number may reflect the degree how enthusiastically the audience discuss the content of each page. Additionally, the behavior analysis module 1635 may further collect assessments of the audience apparatuses 14 showing support or nonsupport to the questions, so as to reflect comments or assessments of the audience or the speaker on the questions.

In other embodiments, the behavior analysis module 1635 may also summarize the sequence of each audience apparatus 14 reading each page to provide the speaker with a reference indicator whether the pages are put in an improper order. Alternatively, the behavior analysis module 1635 may calculate the frequency of each audience apparatus 14 switching each page, such that the speaker may be provided with the assessment with respect to personalities of the audience to adjust data weight of each content of the presentation data.

It should be mentioned that besides individually performing analysis on different usage behavior in the embodiments above, the server applying the present embodiment may select to perform comprehensive analysis on the usage behaviors of various types according to actual design requirements to serve the analysis result as the feedback of the lecture, and the invention is not limited thereto.

It is to be noted that the invention further provides an information update mechanism after the lecture, such that the speaker or the audience may update or feedback the contents of the presentation data. In detail, modules recorded in the storage unit 163 of the server 15 may include a presentation data updating module (not shown) which receives an inquiry request of the speaker apparatus 12 or each audience apparatus 14 through the communication unit 161 to add the marks provided by each audience apparatus 14 in each page of the presentation data, such that a presentation data capable of summarizing the marks from all of the audience may be provided. Alternatively, the presentation data updating module may collect the questions raised by each audience apparatus 14 on each page and provide a list of the collected questions to the speaker apparatus 12 or each audience apparatus 14.

By the above-mentioned method, the server 16 of the present embodiment may provide the feedback information with reference value to the speaker apparatus 12 or the audience apparatuses 14. Thereby, the speaker may be aware of which parts the audience have difficulty to understand according to the questions, while the audience may also be aware of points of the questions from others or marks made by others, such that the learning effect may be improved. It should be mentioned that after the lecture, the invention also provides the speaker with reviewing according to the feedback of the lecture, so as to update the presentation data or the lecture contents thereof. An example describing a method for lecture feedback of the present embodiment will be provided below.

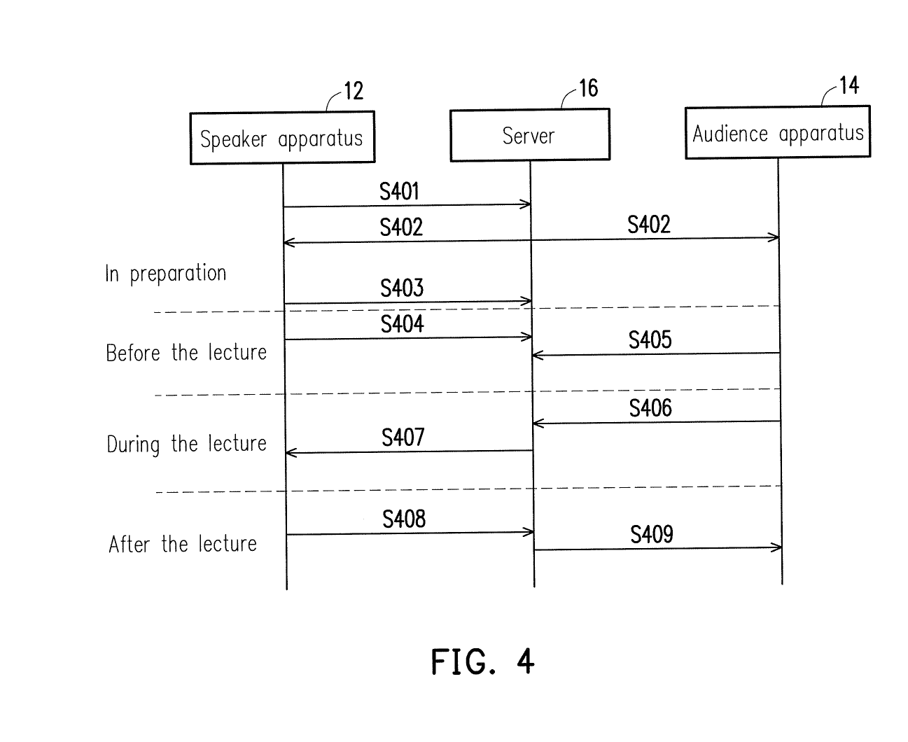

FIG. 4 illustrates an example of the lecture feedback according to an embodiment of the invention. Referring to FIG. 4, the example is applicable to the lecture feedback system 10 illustrated in FIG. 1, steps of this example will be described with reference to the speaker apparatus 12, the audience apparatus 14 and the server 16 illustrated in FIG. 1.

During a lecture preparation stage, the application installed in the speaker apparatus 12 may receive an operation of newly adding a lecture from a speaker and send an adding request of a lecture to the server 16 (step S401). The server 16 may generate an ID according to the received adding request and respectively send the ID to the speaker apparatus 12 and the audience apparatuses 14 (step S402). In this way, the speaker apparatus 12 may allow the speaker to upload a presentation data to the server 16 by using the ID on a web page provided by the server 16 (step S403).

Before the lecture starts, the speaker apparatus 12 may provide the speaker to select whether to activate a speaker mode and after receiving the operation of activating the speaker mode, confirm whether the speaker opens the presentation data and transmit a message with respect to the activation of the speaker mode to the server 16 (step S404). On the other hand, the server 16 may receive login information including the ID transmitted by the audience apparatus 14, so as to add the audience apparatus 14 to the lecture and activate an audience mode (step S405). Detailed login method has been described in the embodiments above and thus will not be repeatedly described hereinafter.

During the lecture, the speaker apparatus 12 may provide, for example, a laser stylus function to assist the speaker in proceeding the lecture, the presentation data is displayed on each audience apparatus 14, such that the audience may mark or add notes, input questions or reply to questions raised by others on the presentation data. The audience apparatus 14, for example, may transmit the questions raised by the audience, the replies or supplementations to the questions provided by the audience to the server 16 (step S406). The server 16 then may collect the questions provided by the audience apparatuses 14 in a question list and provide the question list to the speaker apparatus 12 (step S407). Thereby, the speaker may view the question list in the speaker apparatus 12 any time, click on a page number of a page where the questions are located to directly jump to the page and provide explanations to the questions raised by the audience.

Finally, after the lecture is finished, the server 16 may upload information, such as the list of the questions raised by the audience apparatus 14 during the lecture, the duration of the audience apparatus 14 staying on each page, contents marked by the audience apparatus 14 on each page, to the speaker apparatus 12. The speaker apparatus 12 may not only display the information, but also allow the speaker to modify the presentation data according to the information and upload the modified presentation data to the server 16, so as to update the presentation data on the server 16 (step S408). Additionally, the speaker apparatus 12 may further allow the speaker to duplicate the settings of the current lecture and select one version of the presentation data to serve as the presentation data for a next lecture. On the other hand, the audience apparatus 14 may also provide the audience to view the question list collected by the server 16, the updated presentation data and messages provided by other speakers (step S409), such that the audience may track messages following the lecture.

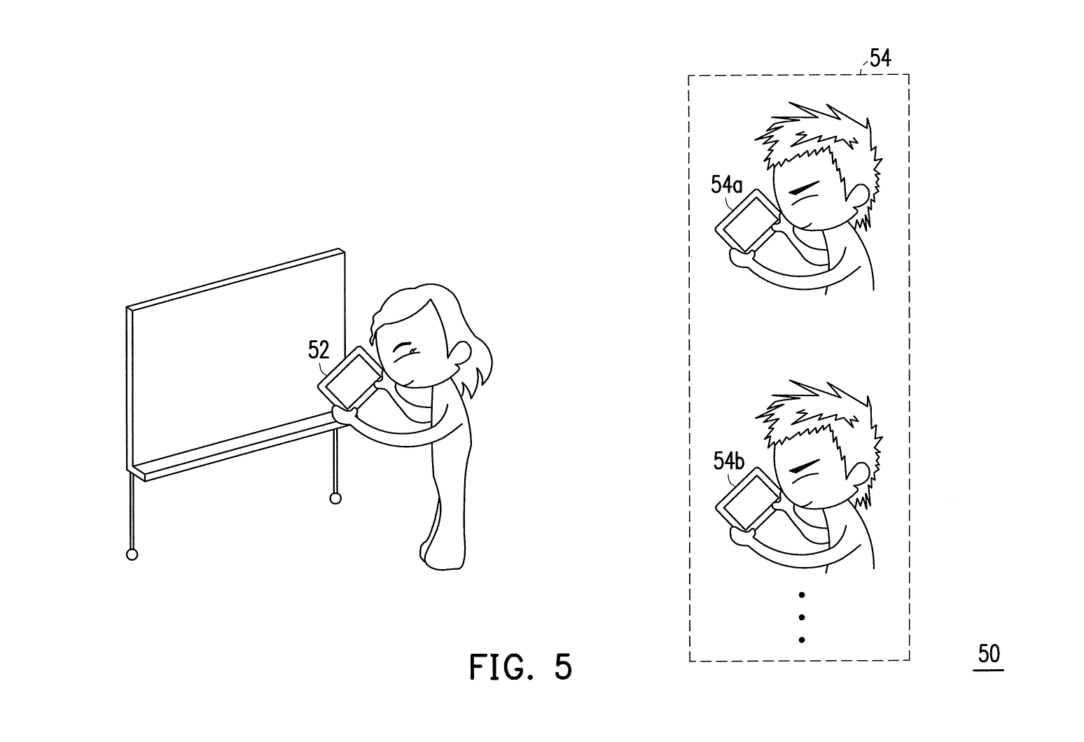

FIG. 5 is a schematic diagram illustrating a lecture feedback system according to another embodiment of the invention. Referring to FIG. 5, a lecture feedback system 50 of the present embodiment includes a lecture feedback apparatus 52 and at least one audience apparatus 54 (e.g., the audience apparatuses 54a and 54b). The lecture feedback system 50 of the present embodiment is different from the lecture feedback system 10 of FIG. 1 in that in the lecture feedback system 50, the lecture feedback apparatus 52 communicates with the audience apparatus 54 directly to provide a lecture feedback. The type and function of the audience apparatuses 54 are the same as or similar to the audience apparatuses 14 described in the embodiments above and thus will not be repeatedly described.

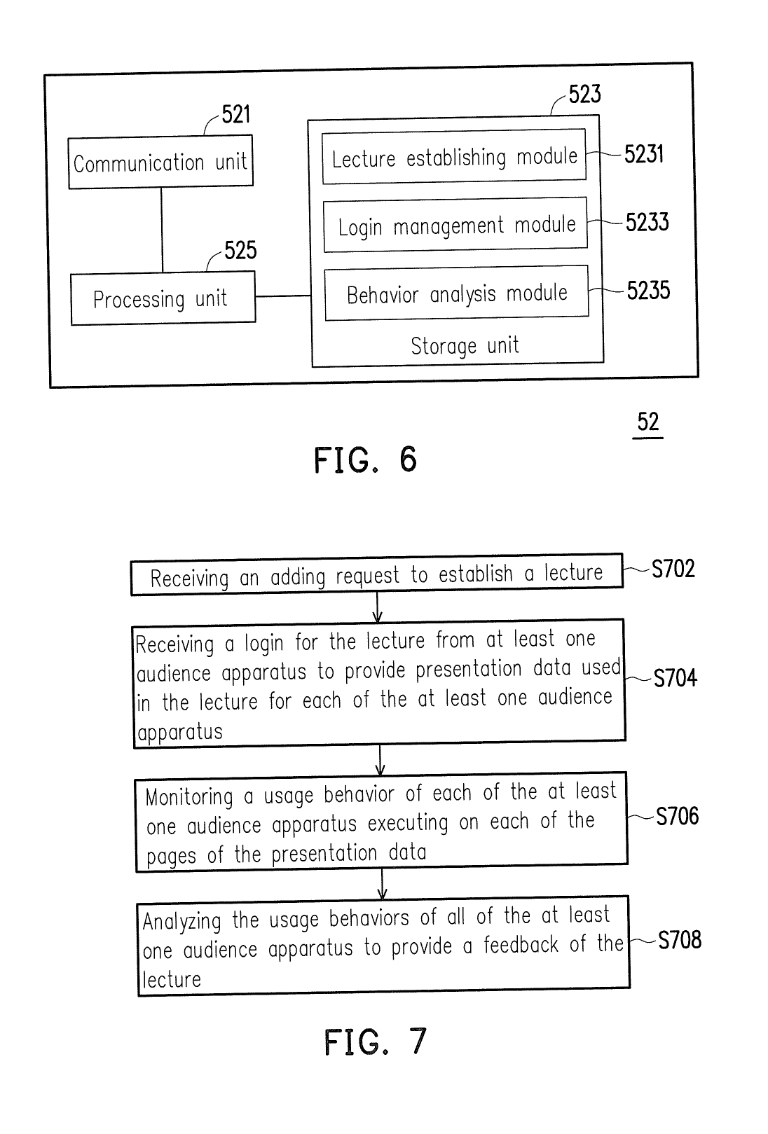

FIG. 6 is a block diagram illustrating a lecture feedback apparatus 52 of the lecture feedback system 50 depicted in FIG. 5 according to an embodiment of the invention. Referring to FIG. 6, the lecture feedback apparatus 52 includes a communication unit 521, a storage unit 523 and a processing unit 525. The types and functions of the communication unit 521, the storage unit 523 and the processing unit 525 in the lecture feedback apparatus 52 are respectively the same as or similar to the communication unit 161, the storage unit 163 and the processing unit 165 described in the embodiments above and thus, will not be repeatedly described. It is to be mentioned that in the present embodiment, the lecture feedback apparatus 52 may directly establish connection with the audience apparatuses 54a and 54b for data transmission through the communication unit 161 by using a peer-to-peer (e.g., D2D or WiFi Direct) technique.

FIG. 7 is a flowchart of a method for lecture feedback according to an embodiment of the invention. Referring to FIG. 7, the method of the present embodiment is applicable to the lecture feedback apparatus 52 of FIG. 6, and detailed steps of the method for lecture feedback of the present embodiment will be described with reference to the operation of each component of the lecture feedback apparatus 52 and each audience apparatus 54 depicted in FIG. 5.

First, a lecture establishing module 5231 of the lecture feedback apparatus 52 receives an adding request operated by a speaker through the communication unit 521 to establish a lecture (step S702). For example, the lecture establishing module 5231 provides an operating interface for the speaker to select or upload a presentation data. After the lecture is established and the presentation data is newly added by the lecture establishing module 5231, a login management module 5233 receives a login for the of lecture from each audience apparatus 54 through the communication unit 521 so as to provide the presentation data of the lecture to each audience apparatus 54, where the presentation data includes a plurality of pages (step S704). For example, the login management module 5233 may communicate with each audience apparatus 54 in a peer-to-peer manner through the communication unit 521 and receives a login request of each audience apparatus 54. After receiving the login request, the login management module 5233 may transmit the presentation data through the communication unit 521 to each audience apparatus 54 sending the login request.

Then, a behavior analysis module 5235 of the lecture feedback apparatus 52 monitors a usage behavior of each of the audience apparatuses 54 executing on each page of the presentation data (step S706). For example, the behavior analysis module 5235 may monitor one or a combination of durations of the audience apparatuses 54 staying on each page, contents marked on each page, questions raised during a display of each page, replies to each question, a sequence of reading each page and a frequency of switching each page.

After receiving data with respect to the usage behavior of each audience apparatus 54, the behavior analysis module 5235 of the lecture feedback apparatus 52 analyzes the usage behaviors of all of the audience apparatuses 524 to provide a feedback of the lecture through the communication unit 521 (step S708). For example, the behavior analysis module 5235 may analyze information with respect to the content marks, highlights or notes made by the audience apparatus 54 on each page, calculate the number of the questions raised and the number of assessments made to the questions during the display of each page. Steps S702 through S708 in FIG. 7 are respectively the same as or similar to steps S302 through S308 of the embodiment illustrated in FIG. 3 and thus, will not be repeatedly described. In other words, the method for lecture feedback performed in the server 16 depicted in FIG. 3 may also directly performed by using the lecture feedback apparatus 52.

To summarize, in the method, the server and the apparatus for lecture feedback of the invention, the usage behaviors, such as the durations of the audience apparatuses staying on each page, the contents marked by each audience on each page, the questions raised and the replies to each question provided during the display of each page are monitored and analyzed, such that feedback information with a reference value can be provided to the speaker or the audience for reference. In this way, the invention can not only facilitate the speaker in instantly obtaining the questions and responses of the audience to the lecture contents, but also facilitate the audience in learning questions raised by others and responding thereto, such that the learning effect can be improved.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A method for lecture feedback, adapted to provide a feedback of a lecture, the method comprising:
receiving an adding request to establish the lecture;
receiving a login for the lecture from at least one audience apparatus to provide a presentation data used in the lecture for each of the at least one audience apparatus, wherein the presentation data comprises a plurality of pages;
monitoring a usage behavior of each of the at least one audience apparatus executing on each of the pages of the presentation data; and
analyzing the usage behaviors of all of the at least one audience apparatus to provide the feedback of the lecture.

2. The method according to claim 1, wherein the step of receiving the adding request to establish the lecture comprises:
broadcasting an identification (ID) of the lecture; and
receiving the presentation data uploaded by using the ID.

3. The method according to claim 2, wherein the step of receiving the login for the lecture comprises:
receiving login information uploaded by each of the at least one audience apparatus; and
determining whether to accept the login for the lecture of each of the at least one audience apparatus according to the login info iation, wherein the login information includes the ID of the lecture or location information of each of the at least one audience apparatus.

4. The method according to claim 1, wherein the step of monitoring the usage behavior of each of the at least one audience apparatus executing on each of the pages of the presentation data comprises:
monitoring one or a combination of a duration of each of the at least one audience apparatus staying on each of the pages, contents marked on each of the pages, questions raised during a display of each of the pages, a reply to each of the questions, a sequence of reading each of the pages and a frequency of switching each of the pages.

5. The method according to claim 4, wherein the step of analyzing the usage behaviors of all of the at least one audience apparatus to provide the feedback of the lecture comprises:
accumulating the durations of all of the at least one audience apparatus staying on each of the pages to serve the accumulated result as the feedback of the lecture.

6. The method according to claim 4, wherein the step of analyzing the usage behaviors of all of the at least one audience apparatus to provide the feedback of the lecture comprises:
accumulating a number of the contents marked by all of the at least one audience apparatus on each of the pages to serve the accumulated number as the feedback of the lecture.

7. The method according to claim 4, wherein the step of analyzing the usage behaviors of all of the at least one audience apparatus to provide the feedback of the lecture comprises:
accumulating a number of the questions raised by all of the at least one audience apparatus during the display of each of the pages to serve the accumulated number as the feedback of the lecture.

8. The method according to claim 4, wherein the step of analyzing the usage behaviors of all of the at least one audience apparatus to provide the feedback of the lecture comprises:
accumulating a number of the questions raised by all of the at least one audience apparatus during the display of each of the pages, the number of the replies to the questions and the number of assessments of the questions to serve the accumulated numbers as the feedback of the lecture.

9. The method according to claim 4, wherein after the step of analyzing the usage behaviors of all the at least one audience apparatus to provide the feedback of the lecture, the method further comprises:
receiving an inquiry request sent by the at least one audience apparatus to provide the presentation data with the marks adding to each of the pages or a list of the questions collected for each of the pages.

10. A server for lecture feedback, comprising:
a communication unit;
a storage unit, recording a plurality of modules; and
a processing unit, coupled to the communication unit and the storage unit, accessing and executing the modules recorded in the storage unit, wherein the modules comprise:
a lecture establishing module, receiving an adding request sent by a speaker apparatus through the communication unit to establish a lecture;
a login management module, receiving a login for the lecture from at least one audience apparatus through the communication unit to provide a presentation data used in the lecture for each of the at least one audience apparatus, wherein the presentation data comprises a plurality of pages; and
a behavior analysis module, monitoring a usage behavior of each of the at least one audience apparatus executing on each of the pages of the presentation data and analyzing the usage behaviors of all of the at least one audience apparatus to provide a feedback of the lecture through the communication unit.

11. The server according to claim 10, wherein the lecture establishing module broadcasts an ID of the lecture through the communication unit, and receives the presentation data uploaded by the speaker apparatus using the ID through the communication unit.

12. The server according to claim 11, wherein the login management module receives login information uploaded by each of the at least one audience apparatus through the communication unit, and determines whether to accept the login for the lecture of each of the at least one audience apparatus according to the login information, wherein the login information includes the ID of the lecture or location information of each of the at least one audience apparatus.

13. The server according to claim 10, wherein the behavior analysis module monitors one or a combination of a duration of each of the at least one audience apparatus staying on each of the pages, contents marked on each of the pages, questions raised during a display of each of the pages, a reply to each of the questions, a sequence of reading each of the pages and a frequency of switching each of the pages.

14. The server according to claim 13, wherein the behavior analysis module accumulates the durations of all of the at least one audience apparatus staying on each of the pages to serve the accumulated result as the feedback of the lecture.

15. The server according to claim 13, wherein the behavior analysis module accumulates a number of the contents marked by all the at least one audience apparatus on each of the pages to serve the accumulated number as the feedback of the lecture.

16. The server according to claim 13, wherein the behavior analysis module accumulates a number of the questions raised by all the at least one audience apparatus during the display of each of the pages to serve the accumulated number as the feedback of the lecture.

17. The server according to claim 13, wherein the behavior analysis module accumulates a number of the questions raised by all the at least one audience apparatus during the display of each of the pages, the number of the replies to the questions and the number of assessments of the questions to serve the accumulated numbers as the feedback of the lecture.

18. The server according to claim 13, wherein the modules further comprise:
a presentation data updating module, receiving an inquiry request sent by the speaker apparatus or the at least one audience apparatus through the communication unit to provide the presentation data with the marks adding to each of the pages or a list of the questions collected for each of the pages through the communication unit.

19. An apparatus for lecture feedback, comprising:
a communication unit;
a storage unit, recording a plurality of modules; and
a processing unit, coupled to the communication unit and the storage unit, accessing and executing the modules recorded in the storage unit, wherein the modules comprise:
a lecture establishing module, receiving an adding request through the communication unit to establish a lecture;
a login management module, receiving a login for the lecture from at least one audience apparatus through the communication unit to provide a presentation data used in the lecture for each of the at least one audience apparatus, wherein the presentation data comprises a plurality of pages; and
a behavior analysis module, monitoring a usage behavior of each of the at least one audience apparatus executing each of the pages of the presentation data and analyzing the usage behaviors of all of the at least one audience apparatus to provide a feedback of the lecture through the communication unit.

20. The apparatus according to claim 19, wherein the behavior analysis module monitors one or a combination of a duration of each of the at least one audience apparatus staying on each of the pages, contents marked on each of the pages, questions raised during a display of each of the pages, a reply to each of the questions, a sequence of reading each of the pages and a frequency of switching each of the pages , so as to generate a feedback of the lecture.
